(19) United States
(12) Patent Application Publication
(10) Pub. No.: US 2013/0138429 A1
(43) Pub. Date: May 30, 2013

(54) Method and Apparatus for Information Searching

(71) Applicant: Alibaba Group Holding Limited, Grand Cayman (KY)

(72) Inventors: Yue Shen, Hangzhou (CN); Kaimin Jin, Hangzhou (CN)

(73) Assignee: Alibaba Group Holding Limited, Grand Cayman (KY)

(21) Appl. No.: 13/691,268

(22) Filed: Nov. 30, 2012

(30) Foreign Application Priority Data
Nov. 30, 2011 (CN) 201110391864.7

(51) Int. Cl. G06F 17/28

(52) U.S. Cl. CPC G06F 17/28
USPC 704/9

(57) ABSTRACT

Techniques for performing searches using synonym pairs generated from data mining are described herein. These techniques may include receiving, by a server, a query including a keyword. The server may generate multiple synonym pairs associated with the keyword by mining multiple item descriptions under a certain context, and then calculate a comprehensive relevance for individual synonym pair. If the comprehensive relevance is greater than a predetermined value, the server may perform searches based on the individual synonym pair.

### CROSS REFERENCE TO RELATED PATENT APPLICATIONS

This application claims priority to Chinese Patent Application No. 201110391864.7, filed on Nov. 30, 2011, entitled “Method and Apparatus for Information Searching,” which is hereby incorporated by reference in its entirety.

### TECHNICAL FIELD

This disclosure relates to the field of network technologies. More specifically, the disclosure relates to methods and apparatus for searching information.

### BACKGROUND

A keyword search is a major search method currently adopted by many search engines. The keyword search may be performed based on a keyword and synonyms of the keyword. Some techniques (e.g., text mining and schema matching) are used to generate synonyms for keyword searches, and therefore increase search efficiency. However, these techniques have problems identifying synonyms under specific contexts. For example, the text mining relies on text similarity algorithms (e.g., an edit distance algorithm) and synonym dictionaries to screen and match synonyms. However, if not included in the synonym dictionaries, synonyms under specific contexts may not be identified.

### SUMMARY

Described herein are techniques for data mining for searches. The techniques may receive a query including a keyword. The techniques may also generate synonym pairs associated with the keyword by mining item descriptions associated with electronic commerce. Based on the synonym pairs, searches may be performed in response to the received query.

This Summary is not intended to identify all key features or essential features of the claimed subject matter, nor is it intended to be used alone as an aid in determining the scope of the claimed subject matter.

### BRIEF DESCRIPTION OF THE DRAWINGS

The Detailed Description is described with reference to the accompanying figures. The use of the same reference numbers in different figures indicates similar or identical items.

FIG. 1 illustrates an example architecture that includes server(s) for performing data mining and/or searches.

FIG. 2 illustrates an example flow diagram for data mining.

FIG. 3 illustrates an example table showing synonym pairs and comprehensive relevances under selected categories.

FIG. 4 illustrates an example server that may be deployed in the architecture of FIG. 3.

### DETAILED DESCRIPTION

The discussion below describes specific exemplary embodiments of the present disclosure. The exemplary embodiments described here are for exemplary purposes only, and are not intended to limit the present disclosure.

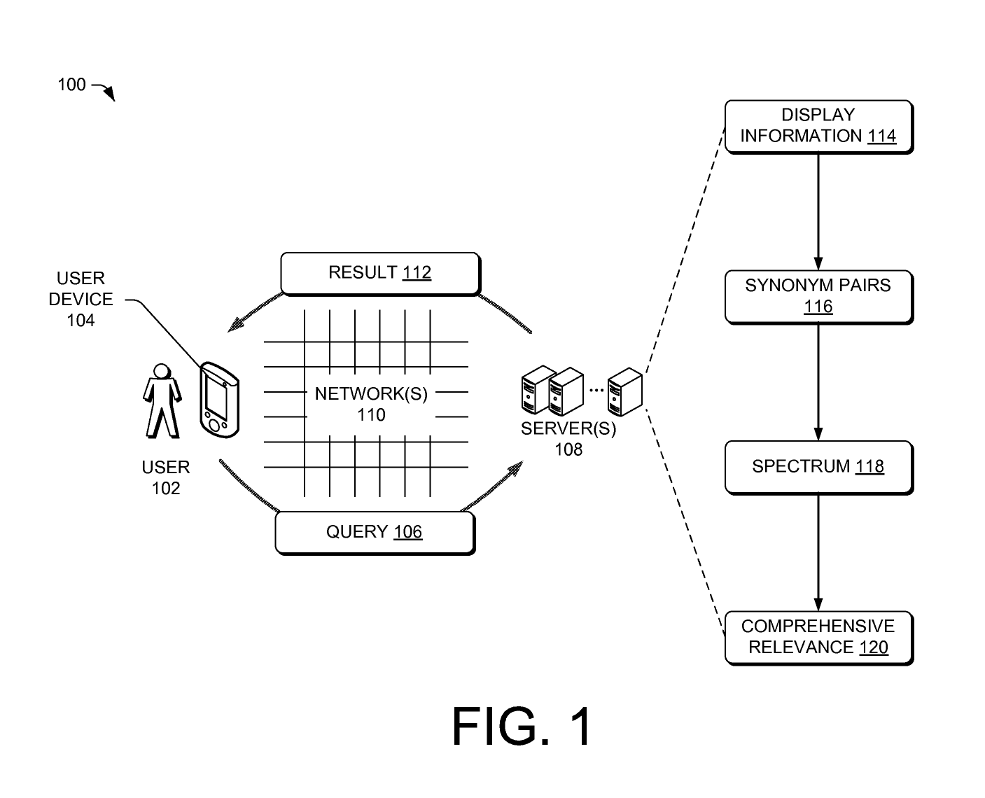

FIG. 1 illustrates an example architecture 100 that includes server(s) for perform data mining and searches. A user may submit a query to a server, and the server may perform searches and return results. The query may include a word. In some embodiments, the server may mine multiple item descriptions (e.g., online advertisements) of items under a category of transactional items to generate multiple synonym pairs including the word. The server may further calculate a comprehensive relevance of an individual synonym pair of the multiple synonym pairs. The comprehensive relevance may indicate attributes of the word and relevances between the word and synonyms of the word within the multiple synonym pairs. If the comprehensive relevance is greater than a predetermine value, the server may perform a search based on a synonym of the word.

In the illustrated embodiment, the techniques are described in the context of a user 102 operating a user device 104 to submit a query 106 to one or more server(s) 108 over one or more network(s) 110. The server 108 may perform a search based on these terms, and return a result 112 to the user device 104.

Here, the user 102 may submit the query 106 via network 110. The network 110 may include any one or combination of multiple different types of networks, such as cable networks, the internet, and wireless networks. The user device 104, meanwhile, may be implemented as any number of computing devices, including as a personal computer, a laptop computer, a portable digital assistant (PDA), a mobile phone, a set-top box, a game console, a personal media player (PMP), and so forth. The user device 104 is equipped with one or more processors and memory to store applications and data. An application, such as a browser or other client application, running on the user device 104 may facilitate submission to the server 108 over network 110.

In architecture 100, the server 108 may mine display information 114 (e.g., online advertisements of items) to generate synonym pairs 116 each including a word and a synonym of the word. In some embodiments, the server 108 may be employed by electronic commerce websites, and the display information 114 may include item advertisement information provided by vendors that desire selling the items.

Based on the synonym pairs 116, the server 108 may then calculate a spectrum 118 of an individual synonym pair to indicate attributes of the word and relevances between the word and synonyms of the word. In some embodiments, the spectrum 118 may include a contextual parameter that indicates a relevance between the word and a synonym of the individual synonym pair. The spectrum 118 may also include attribute parameters of the individual synonym pair that indicate attributes of words of the individual synonym pair. The attribute parameters may be determined based on a predetermined rule. Based on the contextual parameter and attribute parameters, the server 108 may calculate a comprehensive relevance 120 of the individual synonym pair.

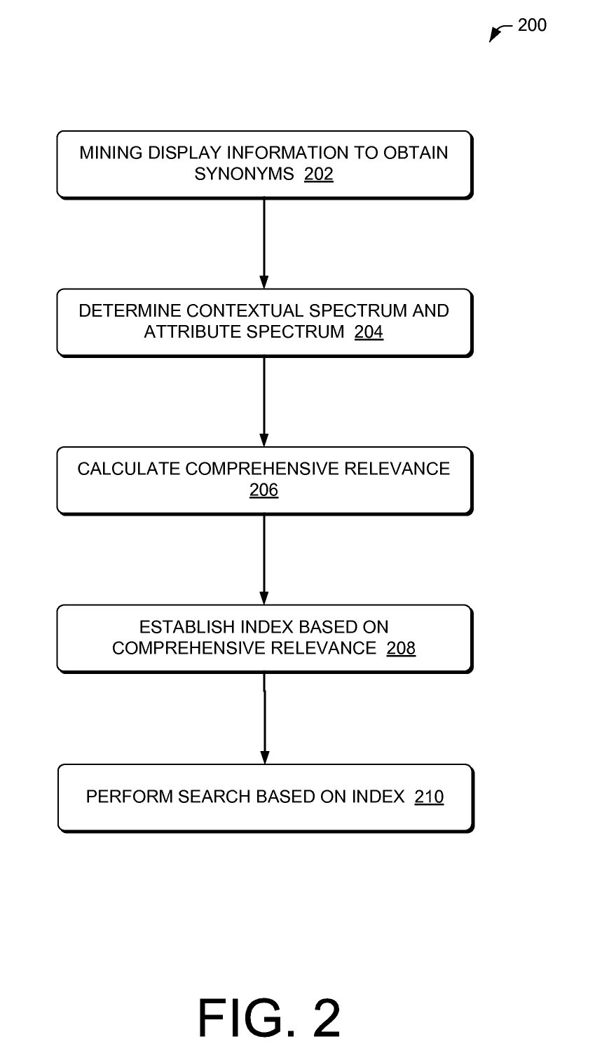

FIG. 2 illustrates a flow diagram 200 for data mining. At 202, the server 108 may mine display information to obtain synonyms. In some embodiments, the server 108 may obtain display information of a selected category, and identify synonym pairs in the obtained display information.

By using conventional technologies, synonym pairs under overall situation rather than specific contexts may be obtained. For example, under the overall situation, Nokia mobile phone model numbers 5800 and 5230 are not synonyms; but these two mobile phones can use a same type of phone cases. Accordingly, under the specific context of phone cases, 5800 and 5230 may be regarded as a synonym pair.

The techniques described herein may determine synonym pairs under specific contexts or meanings, and obtain synonym pairs under the specific contexts. The specific contexts may refer to one or more predetermined categories of translational items (e.g., phone cases and mobile phone). In some embodiments, the categories may be determined based on a predetermined rule. In these instances, translational items associated with an electronic commence service provider may be represented using a hierarchical tree structure including a root node and a collection of children nodes. A node of the tree structure may include multiple items sharing one or more attributes associated with the multiple items. A category may correspond to a node of the tree structure, and therefore to a context.

At 204, the server 108 may determine contextual spectrums and attribute spectrums based on the obtained synonym pairs. In some embodiments, the server 108 may determine the context spectrums and the attribute spectrums of words contained in the obtained synonym pairs. In these instances, the context spectrums may include relevances between common words contained in the pairs and synonyms of the common words. The attribute spectrums may include attributes of words contained in the pairs and weights of each of the attributes.

For each of the synonym pairs discovered from the display information under selected categories, the context spectrum and the attribute spectrum of the synonym pair may be determined. The context spectrum may include relevances between common words contained in the synonym pair and synonyms of the words. For example, under the category of mobile phones, characteristic information of the display information contains a word “Nokia”, and according to statistical data, words that occur together with “Nokia” are “mobile phones”, “ [symbol] ”, “n73”. Thus, these three words and corresponding relevances between the three words and the word “Nokia” may constitute the context spectrum of the word “Nokia”. The attribute spectrum may include attributes of words contained in the synonym pair and weights of the attributes. For example, under the category of mobile phones, the display information contains a word “Nokia n73”, wherein an attribute of this word is a brand name “Nokia”; another attribute is a model number “n73”. Accordingly, the two attributes including the brand name and the model number and the corresponding weights may be the attribute spectrum of the word “Nokia n73”.

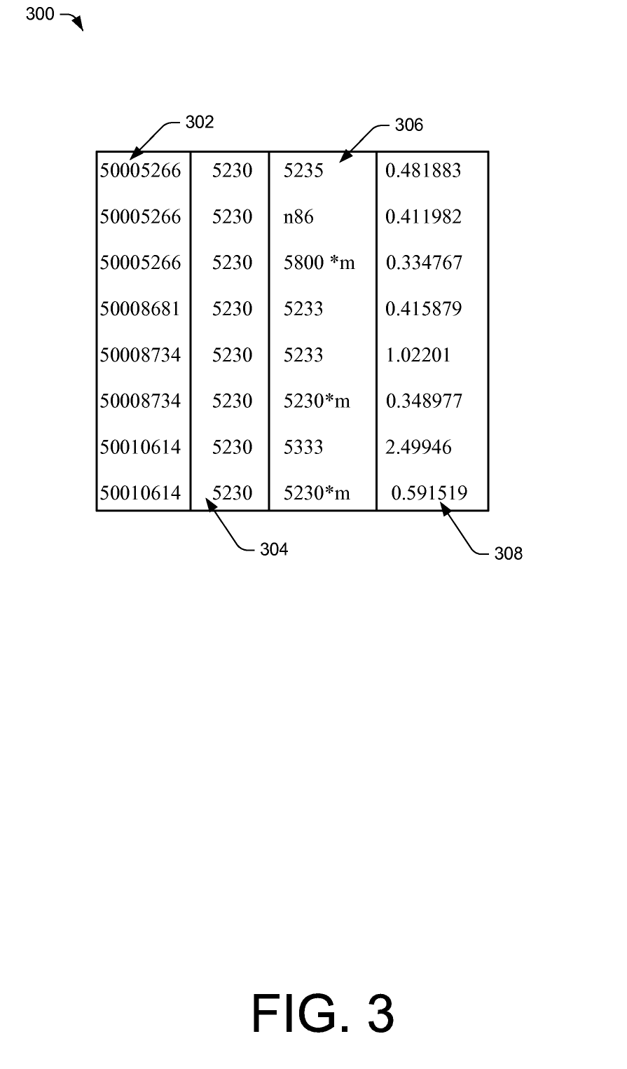

At 206, the server 108 may calculate a comprehensive relevance of a synonym pair. In some embodiments, with respect to each synonym pair, the server 108 may calculate a comprehensive relevance, and establish a common search index for synonym pairs that have comprehensive relevances greater than a predetermined value or meeting one or more preset criteria. For each synonym pair discovered, a comprehensive relevance may be calculated based on a contextual parameter and attribute parameters (e.g., a context spectrum and the attribute spectrum) of the words contained in the synonym pair. In some embodiments, the comprehensive relevance may represent the relevance of the synonym pair or the synonymity of the synonym pair. FIG. 3 is an illustrated table 300 showing synonym pairs and comprehensive relevances under selected categories. In the illustrated embodiment, synonym pairs under the category of mobile phones are shown as an example. A column 302 may include numbers of leaf categories under the category of mobile phones. Columns 304 and 306 may include the synonym pairs. A column 308 may include comprehensive relevances of the synonym pairs.

In some embodiments, a common search index may be established for synonym pairs that meet one or more criteria. The criteria may be determined based on predetermined requirements. The criteria may be a threshold value of the relevances. The comprehensive relevances of synonym pairs may be compared with the threshold value of relevance. When greater comprehensive relevances represents higher synonymity of words contained in a synonym pair, a common search index may be established for synonym pairs that have a comprehensive relevances no less than the threshold value. When less comprehensive relevances represents higher synonymity, a common search index may be established for synonym pairs that have a comprehensive relevances no more than the threshold value.

At 208, the server 108 may establish indexes based comprehensive relevances. In some embodiments, the common search index may be used to search when user-inputted search information includes words contained in synonym pairs for which the common search index is established. At 210, the server may perform a search based on the index established in 208.

According to conventional technologies, the word “apple” means a kind of fruit, while “iphone” is a brand name of mobile phones. In other words, “apple” and “iphone” cannot be synonyms under the overall situation. However, under the category of mobile phones, “apple” and “iphone” are both brand names of mobile phones and are a pair of synonyms. After performing operations 202-208, the server 108 may determine “apple” and “iphone” to be synonyms under the category of mobiles. Search engines may then establish a common search index for “apple” and “iphone” under the category of mobile phones. When a user inputs “apple” or “iphone” into the user terminal for searching, there is no need to perform searches for “apple” and “iphone” separately.

For another example, under the overall situation, Nokia mobile phone model numbers 5800 and 5230 are not synonyms. But these two models of mobile phones can use a same phone case. Therefore, under the category of phone cases, 5800 and 5230 may be synonyms, and a common search index may be established for 5800 and 5230 under the category of phone cases. When a user searches for 5800 or 5230 at the user terminal, there is no need to perform separate searches for 5800 and 5230. Accordingly, from the above two examples, it may be concluded that using a common search index to perform searches can greatly improve search speed.

In some embodiments, discovering synonym pairs under selected categories may provide a premise for discovering synonym pairs under specific contexts. In these instances, a comprehensive relevances may be calculated based on context spectrums and attribute spectrums. The context spectrum may include relevance between words contained in a synonym pair and the words' synonyms. The attribute spectrums may include the attributes of the words contained in the synonym pair and weights of each of said attributes. Criteria may be determined based on predetermined rules, and a common search index may be established for synonym pairs that fulfill the criteria. By considering factors such as the context spectrums and the attribute spectrums, the synonym pairs discovered may better reflect users' search intentions as well as the contexts, and therefore reduce the possibility of generating ambiguity of synonym pairs. Therefore, the synonym pairs described herein are more efficiently discovered, and search efficiencies of search engines are improved.

In some embodiments, the server 108 may determine synonym pairs by analyzing characteristic information of display information and/or historical search information under the selected category. In these instances, the server 108 may segment characteristic information of display information under selected categories using a word as a unit. The server 108 may record co-occurrence word pairs and a number of time that the co-occurrence word pairs are found in the segmented characteristic information of the display information. The co-occurrence word pairs in the segmented characteristic information of the display information may be deemed as synonym pairs if the number of time is greater than a predetermined threshold value.

The characteristic information of the display information under selected categories may be titles, prices and/or description information. For example, titles of display information under a selected category may include descriptions of displayed items, and the titles may also include words that are found together. For example, a title reads “red chiffon . . . 2011 new arrival stylish strap dress . . . strap one-piece dress”.

After segmentation, “strap dress” and “strap one-piece dress” may be determined as repetitive expressions of the same meaning. Words occurring together in the title may be determined as co-occurrence word pairs, and the number of times that such co-occurrence word pairs occur together may be also counted. The co-occurrence word pairs in a title may be synonym pairs or collocation pairs. Therefore the predetermined threshold value may be selected to determine that the co-occurrence word pairs are synonym pairs if the number of times that the co-occurrence word pairs occur together is no less than the predetermined threshold value.

The predetermined threshold value may be determined based on a predetermined rule. If there is a relatively higher requirement for synonymity of the synonym pairs, relatively greater the threshold value may be determined.

In some embodiments, the server 108 may obtain historical search information under the selected category. The server 108 may segment the characteristic information of the display information and the historical search information under the selected category using a word as a unit. The server 108 may record co-occurrence word pairs in the segmented characteristic information of the display information and a number of times that the co-occurrence word pairs occur together. In addition, the server 108 may determine co-occurrence word pairs in the segmented historical search information and a number of times that such co-occurrence word pairs occur together. In these instances, the server 108 may determine the co-occurrence word pairs in the segmented characteristic information of the display information as synonym pairs when the number of times that the co-occurrence word pairs occur together in the segmented characteristic information of the display information is no less than a predetermined threshold value, and the number of times that the co-occurrence word pairs occur together in the historical search information is no greater than another predetermined threshold value.

In some embodiments, a search method using historical information may be used to remove some pairs from the co-occurrence word pairs to obtain redefined synonym pairs (e.g., more relevant synonym pairs). Titles of display information may be provided by sellers who usually use many repetitive words to describe the items. Therefore, co-occurrence word pairs in titles of display information may be collocation pairs or synonym pairs. However, users using user terminals to perform searches usually have clear search intentions, and therefore search information provided by users may be usually brief and clear without redundant information. Expressions of the same meaning may not be inputted when users perform searches. For example, when a user searches for chiffon dresses, he or she may input “red chiffon dress” rather than “red chiffon dress . . . dress”.

In some embodiments, if co-occurrence word pairs that occur many times in the title of display information also occur together in users' search information, then basically such co-occurrence word pairs may not be considered as synonyms. In these instances, the server 108 may identify co-occurrence word pairs that occur many times in the title of display information but rarely occur in users' search information and determine these co-occurrence word pair as synonym pairs or candidates of synonym pairs.

In some embodiments, historical search information of users may be obtained when obtaining the title of the display information. In these instances, the title of the display information and the historical search information under selected categories may be segmented using a word as a unit. Co-occurrence word pairs in the segmented title of the display information and the number of times that such co-occurrence word pairs occur together may be recorded. The co-occurrence word pairs in the segmented historical search information and the number of times that such co-occurrence word pairs occur together may also be recorded. When the number of times that the co-occurrence word pairs occur in the segmented title of the display information is no less than a first threshold value, and the number of times that the co-occurrence word pairs occur in the historical search information is no more than a second threshold value, the co-occurrence word pairs in the title of the display information may be determined as synonym pairs.

In these instances, the first and second threshold values may be determined based on predetermined rules respectively. Alternatively, the first and second threshold values may be determined based on a predetermined rule. For example, the predetermined rule may include a correlation between the first and second threshold values. If there is a relatively higher first threshold for synonymity of the synonym pairs, a relatively smaller second threshold value may be selected; otherwise, a relatively greater second threshold value may be selected. By comparing the number of times that the co-occurrence word pairs occur with the first and second threshold values, the server 108 may filter the collocation pairs out to obtain refined synonym pairs.

In some embodiments, the server 108 may calculate a context spectrum for individual synonym pair. In these instances, for each word contained in each synonym pair, the server 108 may determine synonym pairs that the word is found in and a number of times that such containing synonym pair is found. Based on the number and the total number of synonym pairs discovered from the display information, the server 108 may determine the relevance between the word and its synonym contained in the pair. The context spectrum of the word contained in the synonym pair may then be determined based on the relevance between the word and its synonym in the pair.

Synonym pairs containing the same word may be located, and a number of times that these synonym pairs occur as well as the total number of synonym pairs discovered from the display information may also be determined. The quotient of the number of times that a synonym pair occur divided by the total number of synonym pairs discovered from the display information may indicate the relevance between the two words in the synonym pair. Accordingly, relevances of words contained in all synonym pairs may be obtained. Since all of such synonym pairs contain the same word, relevances between the word in common and all of its synonyms may be obtained, and therefore the context spectrum of the word may be obtained. In other embodiments, the relevances may be calculated using various methods.

In some embodiments, an attribute spectrum of a word may be obtained by determining all attributes of a word in a synonym pair and determining a weight for each of the attributes based on the number of attributes of the word. The attribute spectrum of the word may be calculated based on the word's attributes and the weights of the attributes. For example, the word “Nokia n73” has two attributes: a brand name and a model number. Thus, the brand name and model number attributes each has a weight value of 0.5, and the attribute spectrum of the word “Nokia n73” may be represented as: brand name 0.5, model number 0.5.

In some embodiments, a comprehensive relevances of a synonym pair may be calculated based on the context spectrums and the attribute spectrums of words contained in the synonym pair. Based on the context spectrums of words contained in a synonym pair, the server 108 may calculate one or more common synonyms of the words contained in the pair, and relevances between the words contained in the pair and their common synonyms. The server may also calculate relevances between the context spectrums of the synonym pair based on the common synonyms and the relevances between the words contained in the pair and their common synonyms. Based on the attribute spectrums of the words contained in the synonym pair, the server 108 may calculate common attributes of the words contained in the pair and weights of the common attributes in the attribute spectrums of the words contained in the pair. The server 108 may also calculate a relevance of attribute spectrums of the synonym pair based on the common attributes and the weights of the common attributes in the attribute spectrums of words contained in the pair. The server 108 may calculate a comprehensive relevances of the synonym pair based on the relevance of the context spectrums and the relevance of the attribute spectrums of the synonym pair.

For example, the server 108 may calculate a comprehensive relevances of a synonym pair, taking (A, B) as the exemplary synonym pair. Suppose that the context spectrum of A is represented by a relevance between A and C as S1, a relevance between A and D as S2, and relevance between A and E as S3. Further suppose that the attribute spectrum of A is: brand name 1/3; model number 1/3; color 1/3; the context spectrum of B is represented by a relevance between B and C as S4, a relevance between B and D as S5, and a relevance between B and F as S6; and the attribute spectrum of B is: brand name 1/2; model number 1/2.

To calculate the relevance of context spectrums of (A, B), common synonyms in the context spectrums of A and B and the relevance between such common synonyms and A as well as B may be obtained. In this example, the server 108 may obtain the relevance between the common synonym C and A as well as the relevance between C and B, i.e. S1 and S4, and obtain relevance between the common synonym D and A as well as the relevance between D and B, i.e. S2 and S5. Accordingly, the relevance of the context spectrums of (A, B) is calculated using the following equation.

$$\frac{S 1 \times S 4 + S 2 \times S 5}{\sqrt{[ {( S 1 )}^{2} + {( S 2 )}^{2} + {( S 3 )}^{2} ] \times [ {( S 4 )}^{2} + {( S 5 )}^{2} + {( S 6 )}^{2} ]}} \qquad ( 1 )$$

The relevance between each of the common synonyms and A as well as B are multiplied, and the sum of which is divided by the square root of the sum of squares of all the relevance in the context spectrum of A and the square root of the sum of squares of all the relevance in the context spectrum of B to calculate the relevance of context spectrums of the synonym pair (A, B).

To calculate the relevance of the attribute spectrums of (A, B), the server 108 may obtain common attributes in the attribute spectrums of A and B and weights of such common attributes in each attribute spectrums of A and B need to be obtained. In the present example, suppose that the common attributes are brand name and model number. Also suppose that the weights of the brand name attribute in the attribute spectrums of A and B are 1/3 and 1/2, and the weights of the model name attribute in the attribute spectrums of A and B are 1/3 and 1/2. Therefore, the relevance of the attribute spectrums of the synonym pair (A, B) is calculated as follow:

$$\frac{( 1 / 3 ) \times ( 1 / 2 ) + ( 1 / 3 ) \times ( 1 / 2 )}{\sqrt{[ {( 1 / 3 )}^{2} + {( 1 / 3 )}^{2} + {( 1 / 3 )}^{2} ] \times [ {( 1 / 2 )}^{2} + {( 1 / 2 )}^{2} ]}} .$$

Summation of the relevance of the context spectrums and the relevance of the attribute spectrums of the synonym pair (A, B) may be the comprehensive relevances of the synonym pair (A, B). In addition to using the relevance of the context spectrums and the relevance of the attribute spectrums of the synonym pair (A, B) as the comprehensive relevances, other methods such as weighting may also be adopted to calculate the comprehensive relevances of (A, B).

In some embodiments, after discovering synonym pairs from the display information, with respect to words contained in a synonym pair, the server 108 may determine predicted categories of the words contained in the pair and weights of the predicted category and obtain a category spectrum of the predicted categories and weights of the predicted categories based on predicted categories and a number of clicks of the historical search information in which the words contained in the pair are included. In these instances, the historical search information's predicted categories and the number of clicks of such categories may be determined based on categories to which display information of search results clicked by users belong and the number of clicks of such categories, wherein the search results clicked by the users are corresponsive to the historical search information.

Historical search information in search log may be accessed, categories to which the display information in user clicked search results corresponding to the historical search information belong may be determined, and a number of clicks of such categories may be counted. Accordingly, the predicted categories of the historical search information and the number of clicks of such predicted categories may be obtained. When words in a synonym pair occur in a plurality of historical search information, the common predicted categories of the plurality of historical search information may be determined as the predicted categories of the words contained in the pair, and the quotient of a maximum value of the number of clicks of one of the predicted categories divided by the total number of clicks of the display information may be determined as the weight of that predicted category. Therefore, the category spectrum of words contained in the synonym pair may be calculated.

In some embodiments, the server 108 may calculate a comprehensive relevance of a synonym pair based on a relevance of context spectrums, a relevance of attribute spectrums and a relevance of category spectrums of the synonym pair. These relevances may be calculated based on the context spectrums, attribute spectrums and category spectrums of words contained in the synonym pair respectively. The comprehensive relevances of the synonym pair may be the summation of the relevance of context spectrums, the relevance of attribute spectrums and the relevance of category spectrums of the synonym pair. Alternatively, the comprehensive relevances of the synonym pair may be obtained via weighting and so forth.

In some embodiments, the server 108 may obtain the relevance of category spectrums of the synonym pair based on the category spectrums of words contained in the synonym pair. Based on the category spectrums of words contained in the synonym pair, the server 108 may obtain common categories of words contained in the synonym pair and weights of the common categories in the category spectrums of the words contained in the pair. The server 108 may also obtain the relevance of category spectrums of the synonym pair based on the common categories and the weights of the common categories in the category spectrums of the words contained in the pair.

In some embodiments, a relevance of category spectrums of a synonym pair may be calculated using an equation similar to (1). For example, (A, B) is taken as the exemplary synonym pair. The method for calculating the relevance of category spectrums of the synonym pair may include obtaining common categories of the category spectrums of A and B and weights of the common categories in the category spectrums of A and B. The weights of each of the common categories in the category spectrums of A and B may be multiplied respectively, and then may be divided by the square root of sum of squares of weights of all categories in the category spectrum of A and by the square root of sum of squares of weights of all categories in the category spectrum of B to obtain the relevance of category spectrums of the synonym pair (A, B).

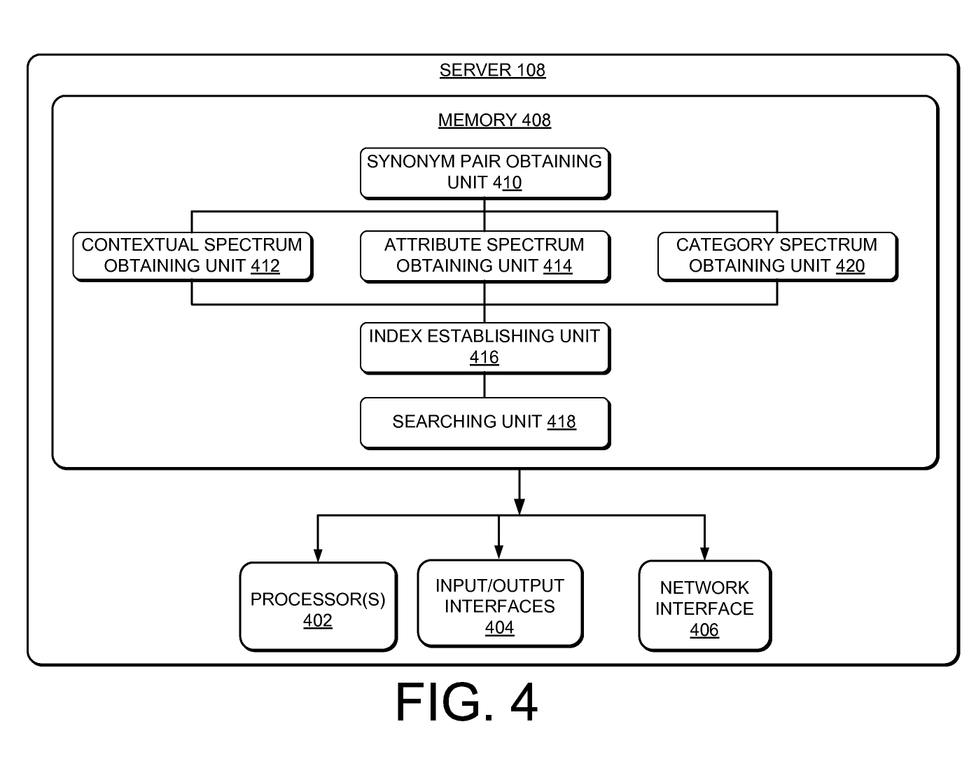

FIG. 4 illustrates an example server 108 that may be deployed in the architecture of FIG. 1. The server 108 may be configured as any suitable computing device(s). In one exemplary configuration, the server 108 includes one or more processors 402, input/output interfaces 404, network interface 406, and memory 408.

The memory 408 may include computer-readable media in the form of volatile memory, such as random-access memory (RAM) and/or non-volatile memory, such as read only memory (ROM) or flash RAM. The memory 408 is an example of computer-readable media.

Computer-readable media includes volatile and non-volatile, removable and non-removable media implemented in any method or technology for storage of information such as computer readable instructions, data structures, program modules, or other data. Examples of computer storage media include, but are not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device. As defined herein, computer-readable media does not include transitory media such as modulated data signals and carrier waves.

Turning to the memory 408 in more detail, the memory 408 may include a synonym pair obtaining unit 410, a context spectrum obtaining unit 412, an attribute spectrum obtaining unit 414, an index establishing unit 416, a searching unit 418 and a category spectrum obtaining unit 420.

The synonym pair obtaining unit 410 may be configured to obtain display information under selected categories and to discover synonym pairs from the display information. The context spectrum obtaining unit 412 may be configured to determine context spectrums of words contained in synonym pairs, wherein the context spectrums comprise relevances between the words contained in the synonym pairs and their synonyms. The attribute spectrum obtaining unit 414 may be configured to determine attribute spectrums of words contained in synonym pairs, wherein the attribute spectrums comprise attributes of the words contained in the synonym pairs and weights of each of the attributes.

The index establishing unit 416 may be configured to obtain a general relevance for each synonym pair based on the context spectrums and the attribute spectrums of the words contained in the synonym pair, and to establish a common search index for synonym pairs which have a general relevance fulfill a preset criteria. The searching unit 418 may be configured to perform searches according to the common search index of the synonym pairs when search information received from users contains words in the synonym pairs.

In some embodiments, the synonym pair obtaining unit 410 may be configured to segment characteristic information of display information under selected category using a word as a unit. The synonym pair obtaining unit 410 may also record co-occurrence word pairs in the characteristic information of the segmented characteristic information of the display information and a number of times that the co-occurrence word pairs occur. The synonym pair obtaining unit 410 may then determine co-occurrence word pairs in the segmented characteristic information of the display information as synonym pairs when the number of times that the co-occurrence word pairs occur is greater than a first threshold value. In some embodiments, the synonym pair obtaining unit 410 may obtain historical search information under selected categories, and segment characteristic information of display information and the historical search information under selected category using a word as a unit, and record co-occurrence word pairs in the segmented characteristic information of the display information and a number of times that such co-occurrence word pairs occur, and record co-occurrence word pairs in the segmented historical search information and a number of times that such co-occurrence word pairs occur. Further, the synonym pair obtaining unit 410 may determine co-occurrence word pairs in the characteristic information of the segmented display information as synonym pairs when the number of times that the co-occurrence word pairs occur is no less than a first threshold value, and the number of times that the co-occurrence word pairs occur in the historical search information is no greater than a second threshold value.

In some embodiments, the context spectrum obtaining unit 412 is configured to, with respect to each word contained in each synonym pair discovered, determine synonym pairs containing the word and the number of times that such synonym pairs occur. The context spectrum obtaining unit 412 determines the relevance between the word contained in the pair and its synonym in the pair based on the number of times that each synonym pair including the word occur and the total number of synonym pairs discovered from the display information. Then, the based on the number of times that each synonym pair including the word occurs and the total number of synonym pairs discovered from the display information may determine the context spectrum of the word contained in the synonym pair based on relevance between the word contained in the pair and its synonym in the pair.

In some embodiments, the index establishing unit 416 is configured to obtain common synonyms for words contained in the synonym pair and relevance between the words contained in the pair and their common synonyms based on the context spectrums of words contained in a synonym pair. Based on the common synonyms and the relevance between the words contained in the pair and their common synonyms, the index establishing unit 416 may obtain the relevance of context spectrums of the synonym pair. The index establishing unit 416 may also obtain common attributes for words contained in the pair and weights of the common attributes in the attribute spectrums of words contained in the pair based on attribute spectrums of words contained in the synonym pair. Based on the common attributes and the weights of the common attributes, the index establishing unit 416 obtain the relevance of attribute spectrums of the synonym pair. Based on the relevance of context spectrums and the relevance of attribute spectrums of the synonym pair, the index establishing unit 416 obtain the general relevance of the synonym pair.

In some embodiments, the memory 408 may also include a category spectrum obtaining unit 420 that may be configured to, for words contained in a synonym pair, based on predicted categories of historical search information of the words contained in the pair and the number of clicks of such predicted categories, determine predicted categories of the words contained in the pair and weights of such predicted categories, and obtain category spectrums including the predicted categories and the weights of the predicted categories of the words contained in the pair. In these instances, the predicted categories of the historical search information and the number of clicks of such predicted categories may be determined based on categories to which display information of search results clicked by users belong and the number of clicks of such categories, wherein the search results clicked by users are corresponsive to the historical search information.

In some embodiments, the index establishing unit 416 may obtain the relevance of context spectrums, the relevance of attribute spectrums and the relevance of category spectrums of the synonym pair based on the context spectrums, the attribute spectrums and the category spectrums of words contained in a synonym pair. Based on the relevance of context spectrums, the relevance of attribute spectrums and the relevance of category spectrums of the synonym pair, the index establishing unit 416 may obtain the general relevance of the synonym pair.

In some embodiments, the index establishing unit 416 may obtain common categories of the words contained in the synonym pair and weights of the common categories in the category spectrums of the words contained in the pair based on the category spectrums of words contained in a synonym pair. Based on the common categories and the weights of the common categories in the category spectrums of the words contained in the pair, the index establishing unit 416 may obtain the relevance of category spectrums of the synonym pair.

The specific examples herein are utilized to illustrate the principles and embodiments of the application. The description of the embodiments above is designed to assist in understanding the method and ideas of the present disclosure. However, persons skilled in the art could, based on the ideas in the application, make alterations to the specific embodiments and application scope, and thus the content of the present specification should not be construed as placing limitations on the present application.

What is claimed is:

1. One or more computer-readable media storing computer-executable instructions that, when executed by one or more processors, instruct the one or more processors to perform acts comprising:
receiving a query associated with a word;
mining multiple item descriptions under a category of items to generate multiple synonym pairs including the word;
calculating a comprehensive relevance of individual synonym pair of the multiple synonym pairs; and
performing a search based on a synonym pair of the multiple synonym pairs that has a comprehensive relevance greater than a predetermined value.

2. The one or more computer-readable media of claim 1, wherein the comprehensive relevance is calculated based on a relevance between the word and the synonym pair.

3. The one or more computer-readable media of claim 1, wherein the comprehensive relevance is calculated based on attributes associated with the word and a synonym of the word in the synonym pair.

4. The one or more computer-readable media of claim 3, wherein the attributes are assigned weights based on a predetermined rule, and the comprehensive relevance is calculated further based on the weights.

5. The one or more computer-readable media of claim 1, wherein the comprehensive relevance is calculated based on category spectrums associated with the word and a synonym of the word in the synonym pair, and the category spectrums are determined based on categories associated with the word and a synonym of the word in the synonym pair and user click-through rates associated with the categories.

6. The one or more computer-readable media of claim 1, wherein the individual synonym pair includes the word and a synonym of the word.

7. The one or more computer-readable media of claim 1, wherein the multiple item descriptions include item advertisement information provided by vendors.

8. The one or more computer-readable media of claim 1, wherein the acts further comprise:
determining a contextual parameter of the individual synonym pair, the contextual parameter indicating a relevance between the word and the individual synonym under the category; and
determining attribute parameters of the individual synonym pair based on a predetermined rule.

9. The one or more computer-readable media of claim 8, wherein the calculating a comprehensive relevance comprises calculating the comprehensive relevance based on the contextual parameter and the attribute parameters.

10. The one or more computer-readable media of claim 8, wherein the acts further comprise:
determining one word of the individual synonym pair;
calculating a number of synonym pairs including the word; and
calculating an additional number of the multiple synonym pairs, and the contextual parameter is determined using the number and the additional number.

11. The one or more computer-readable media of claim 1, wherein the acts further comprise:
conducting segmentations on the multiple item descriptions based on characteristics of multiple item descriptions to generate multiple strings;
identifying at least two words of the multiple strings, the at least two words being found together in at least two strings of the multiple strings;
calculating a frequency that the at least two words are found together in the multiple strings; and
determining that the at least words belong to a synonym pair if the frequency is greater than a predetermined value.

12. The one or more computer-readable media of claim 11, wherein the acts further comprise:
conducting additional segmentations on the multiple item descriptions based on historical searching information under the category of the items to generate additional multiple strings;
determining that the at least two words are found together in at least two additional strings of the additional multiple strings and an additional frequency that the at least two words are found together in the additional multiple strings; and
determining that the at least two words are a synonym pair if the frequency is greater than a predetermined value and the additional frequency is not greater than an additional predetermined value.

13. A computer-implemented method comprising:
mining multiple item descriptions under a category of transactional items to generate a synonym pair including a word and a synonym of the word;
calculating a contextual parameter of the synonym pair, the contextual parameter indicating a relevance between the word and the synonym of the synonym pair;
calculating attribute parameters of the synonym pair based on a predetermined rule; and
calculating a comprehensive relevance of the synonym pair based on the contextual parameter and the attribute parameters.

14. The computer-implemented method of claim 13, further comprising analyzing the item descriptions to generate multiple strings, wherein two words of the synonym pair:
are found together in at least two strings of the multiple strings, and
have a frequency that the two words are found together in the multiple strings and is greater than a predetermined value.

15. The computer-implemented method of claim 13, further comprising:
receiving a query associated with a word;
determining that the comprehensive relevance is greater than a predetermined value; and
in response to the determining, performing a search based on the synonym.

16. The computer-implemented method of claim 13, further comprising:
analyzing the multiple item descriptions based on characteristics of multiple item descriptions to generate multiple strings;
identifying at least two words of the multiple strings that are found together in at least two strings of the multiple strings;
calculating a frequency that the at least two words are found together in the multiple strings; and
determining that the at least words belong to a synonym pair if the frequency is greater than a predetermined value.

17. A computing device comprising:
one or more processors; and
memory to maintain a plurality of components executable by the one or more processors, the plurality of components comprising:
synonym obtaining unit that mines multiple item descriptions under a category of transactional items to generate a synonym pair including a word and a synonym of the word,
contextual spectrum obtaining unit that determines a contextual parameter of the synonym pair, the contextual parameter indicating a relevance between the word and the synonym under the category,
attribute spectrum obtaining unit that determines attribute parameters of the synonym pair based on a predetermined rule,
index establishing unit that calculates a comprehensive relevance of the synonym pair based on the contextual parameter and the attribute parameters, and
searching unit that performs a search based on the synonym pair in response to a query including word.

18. The computing device of claim 17, wherein the synonym obtaining unit further analyzes the item descriptions to generate multiple strings, wherein two words of the synonym pair:
are found together in at least two strings of the multiple strings, and
have a frequency that the two words are found together in the multiple strings and is greater than a predetermined value.

19. The computing device of claim 17, wherein the comprehensive relevance is calculated further based on category spectrums associated with the word and a synonym of the word in the synonym pair, and the category spectrums are determined based on categories associated with the word and the synonym, and user click-through rates associated with the categories.

20. The computing device of claim 17, wherein the synonym obtaining unit further:
analyzes the multiple item descriptions based on characteristics of multiple item descriptions to generate multiple strings;
identifies at least two words of the multiple strings that are found together in at least two strings of the multiple strings;
calculates a frequency that the at least two words are found together in the multiple strings; and
determines that the at least words belong to a synonym pair if the frequency is greater than a predetermined value.
